(19) United States
(12) Patent Application Publication
(10) Pub. No.: US 2026/0302992 A1
(43) Pub. Date: Oct. 1, 2026

(54) ALTERNATING POWER SUPPLY CIRCUIT OF AND ALTERNATING POWER SUPPLY METHOD FOR LONG STATOR LINEAR MOTOR

(71) Applicant: CRRC ZHUZHOU ELECTRIC LOCOMOTIVE RESEARCH INSTITUTE CO., LTD., Zhuzhou, Hunan (CN)

(72) Inventors: Guanglie LI, Zhuzhou, Hunan (CN); Anfeng ZHAO, Zhuzhou, Hunan (CN); Xianzhen YUAN, Zhuzhou, Hunan (CN); Yu SHI, Zhuzhou, Hunan (CN); Yijing XU, Zhuzhou, Hunan (CN); Wenye YUAN, Zhuzhou, Hunan (CN); Yongjiang LIU, Zhuzhou, Hunan (CN); Yingqi GAO, Zhuzhou, Hunan (CN); Guanglin YAN, Zhuzhou, Hunan (CN)

(73) Assignee: CRRC ZHUZHOU ELECTRIC LOCOMOTIVE RESEARCH INSTITUTE CO., LTD., Zhuzhou, Hunan (CN)

(21) Appl. No.: 19/480,705

(22) PCT Filed: Oct. 17, 2023
(86) PCT No.: PCT/CN2023/124889

§ 371 Date: Oct. 31, 2025

(51) Int. Cl. H02P 27/048; H02P 6/00; H02P 6/16; H02P 25/064

(52) U.S. Cl. CPC H02P 27/048; H02P 6/006; H02P 6/16; H02P 25/064

(57) ABSTRACT

An alternating power supply circuit of and an alternating power supply method for a long stator linear motor, and a long stator linear motor, relating to the technical field of motors. The alternating power supply circuit of the long stator linear motor comprises three-phase stator winding branch circuits, the stator winding branch circuits of respective phases being connected to a converter, the stator winding branch circuit of each phase comprising N sections of stator windings connected in series, each section of the stator windings being connected to a switching circuit in parallel, and when the switching circuit is closed, the parallelly-connected stator winding being short-circuited. Using the alternating power supply circuit of the long stator linear motor can increase the speed of switching power supply for stators, thus reducing the usage of power supply devices and system complexity.

### FIELD

The present disclosure relates to the technical field of motors, and in particular to a rolling power supply circuit for a long stator linear motor, a rolling power supply method for a long stator linear motor, and a long stator linear motor.

### BACKGROUND

A linear motor is a new type of motor that directly converts electrical energy into mechanical energy of linear motion, demonstrating broad application prospects in fields such as rail transit. As the core driving component of a rail transit system, a long stator linear motor is of great significance to the development of rail transit. Power supply is critical in a drive system for the long stator linear motor. A power supply method involves providing an alternating current with variable amplitude and variable frequency to a stator through a converter, to supply a power for operation of a rotor through electromagnetic coupling. For the long stator linear motor, stators are laid along the entire line according to requirements, making it difficult to power all the stators simultaneously. In addition, powering all the stators simultaneously results in significant energy loss, greatly reducing the efficiency of the drive system for the motor. In the long stator linear motor, only a part of the stators coupled with the rotor participates in electromechanical energy conversion. Thus, the normal operation of the rotor can be ensured as long as the stator where the rotor is located is powered, meaning that segmented power supply for stators is adopted.

At present, segmented rolling power supply for stators in a long stator linear motor may be implemented through a two-step method or a three-step method. In the two-step method, two power supply devices are configured, and each of the power supply devices supplies power to stators on tracks at a fixed side. During a power supply switching process for stators, a power supply switch for a stator from which a rotor is about to leave is turned off, and an output current of a converter is reduced to zero. Then, a power supply switch for a stator segment to which the rotor is about to move is turned on, and the output current of the converter is increased. The switching causes a fluctuation and loss in a driving force. In the three-step method, three power supply devices alternately power stator segments on both sides, avoiding the fluctuation and loss in the driving force caused by stator segment switching in the two-step method. However, the three-step method requires more power supply devices, resulting in a more complex system. The segmented power supply for stators is also required for ultra-high-speed linear driving. Due to the extremely high speed of a rotor, in the two aforementioned rolling power supply methods, a duration for the switching of the power supply switches and the transition of the converters is long, which significantly affects the continuity and stability of the driving force of the rotor during ultra-high-speed linear driving, ultimately impacting the target speed and the smoothness of a driven object.

In view of this, how to improve the speed of power supply switching for stators and reduce the usage amount of power supply devices and system complexity has become an urgent technical issue to be addressed by those skilled in the art.

### SUMMARY

An objective of the present disclosure is to provide a rolling power supply circuit for a long stator linear motor, to improve the speed of power supply switching for stators and reduce the usage amount of a power supply device and system complexity. Another objective of the present disclosure is to provide a rolling power supply method for a long stator linear motor, and to provide a long stator linear motor, both of which have the above technical effects.

To address the above technical issue, a rolling power supply circuit for a long stator linear motor is provided in the present disclosure. The rolling power supply circuit includes three-phase stator winding branches configured to connect to a converter.

Each of the three-phase stator winding branches includes N stator winding segments connected in series, and the N stator winding segments are connected in parallel to respective switching circuits. In response to a switching circuit among the respective switching circuits being closed, the stator winding segment connected in parallel to the switching circuit is short-circuited.

In an embodiment, the switching circuits connected in parallel to the stator winding segments with a same segment number in the three-phase stator winding branches are controlled by a same control signal.

In an embodiment, head ends of the three-phase stator winding branches are connected to the converter, and tail ends of the three-phase stator winding branches are connected in a star connection manner.

In an embodiment, the respective stator winding segments in the three-phase stator winding branches are equal to each other in length.

In an embodiment, the respective switching circuits each include an electronic switch.

To address the above technical issue, a rolling power supply method for a long stator linear motor, applied to the above-described rolling power supply circuit for a long stator linear motor, is further provided in the present disclosure. The rolling power supply method includes:
opening switching circuits connected in parallel to m stator winding segments among the N stator winding segments in each of the three-phase stator winding branches to enable the m stator winding segments to be powered;
monitoring a position of a rotor;
determining a target stator winding segment from the N stator winding segments based on the position of the rotor; and
opening, based on the position of the rotor, a switching circuit connected in parallel to the target stator winding segment.

In an embodiment, the opening switching circuits connected in parallel to m stator winding segments includes:
opening the switching circuits connected in parallel to the m adjacent stator winding segments among the N stator winding segments in each of the three-phase stator winding branches, where m is greater than or equal to 2.

In an embodiment, the determining the target stator winding segment based on the position of the rotor includes:
determining, in response to the rotor being currently located at an n-th stator winding segment, an (n+m)-th stator winding segment in a movement direction of the rotor as the target stator winding segment.

In an embodiment, the opening, based on the position of the rotor, the switching circuit connected in parallel to the target stator winding segment includes:
in response to a tail end of the rotor leaving the n-th stator winding segment, opening a switching circuit connected in parallel to the (n+m)-th stator winding segment and closing a switching circuit connected in parallel to the n-th stator winding segment.

To address the above technical issue, a long stator linear motor is further provided in the present disclosure. The long stator linear motor includes the above-described rolling power supply circuit for a long stator linear motor.

According to the present disclosure, the rolling power supply circuit for a long stator linear motor includes three-phase stator winding branches configured to connect to a converter. Each of the three-phase stator winding branches includes N stator winding segments connected in series, and the N stator winding segments are connected in parallel to respective switching circuits. In response to a switching circuit among the respective switching circuits being closed, the stator winding segment connect in parallel to the switching circuit is short-circuit.

It can be seen that in the rolling power supply circuit for a long stator linear motor in the present disclosure, stator winding segments are powered or not powered by closing or opening switching circuits, thereby improving the speed of power supply switching for the stator winding segments. In addition, live switching is implemented, which effectively reduces the usage amount of the converter and system complexity and thereby reducing the line cost. Moreover, the control on the rolling power supply circuit is highly flexible, and multiple adjacent stator winding segments are powered simultaneously by opening the switching circuits connected in parallel to the multiple adjacent stator winding segments. Furthermore, by reducing lengths of stator winding segments, increasing a total quantity of the stator winding segments, and adopting switching between multiple series-connected stator winding segments, fluctuations in motor traction force during power supply switching can be reduced.

Both of the rolling power supply method for a long stator linear motor and the long stator linear motor in the present disclosure have the above technical effects.

### BRIEF DESCRIPTION OF THE DRAWINGS

In order to more clearly describe the technical solutions in the embodiments of the present disclosure, drawings to be used in the description of the embodiments of the present disclosure or in the conventional technology are briefly described hereinafter. It is apparent that the drawings described below are merely used for describing the embodiments of the present disclosure and those skilled in the art may obtain other drawings based on the drawings without any creative effort.

FIG. 1 is a schematic diagram of a rolling power supply circuit for a long stator linear motor according to an embodiment of the present disclosure;

FIG. 2 is a flowchart of a rolling power supply method for a long stator linear motor according to an embodiment of the present disclosure;

FIG. 3 is a schematic diagram showing power supply for a long stator linear motor according to an embodiment of the present disclosure;

FIG. 4 is a schematic diagram showing power supply for a long stator linear motor according to another embodiment of the present disclosure;

FIG. 5 is a schematic diagram showing discharging after switching according to an embodiment of the present disclosure;

FIG. 6 is a schematic diagram showing an impedance change after switching according to an embodiment of the present disclosure;

FIG. 7 is a schematic diagram showing power supply for a long stator linear motor according to another embodiment of the present disclosure; and

FIG. 8 is a schematic diagram showing power supply for a long stator linear motor according to another embodiment of the present disclosure.

### DETAILED DESCRIPTION

A core of the present disclosure is to provide a rolling power supply circuit for a long stator linear motor to improve the speed of power supply switching for stators and reduce the usage amount of a power supply device and system complexity. Another core of the present disclosure is to provide a rolling power supply method for a long stator linear motor, and to provide a long stator linear motor, both of which have the above technical effects.

In order to make the purpose, technical solutions and advantages of the embodiments of the present disclosure more clear, the technical solutions in the embodiments of the present disclosure are described clearly and completely hereinafter with reference to the drawings in the embodiments of the present disclosure. Apparently, the described embodiments are only some, rather than all of the embodiments of the present disclosure. Based on the embodiments of the present disclosure, all other embodiments obtained by those skilled in the art without any creative effort fall within the protection scope of the present disclosure.

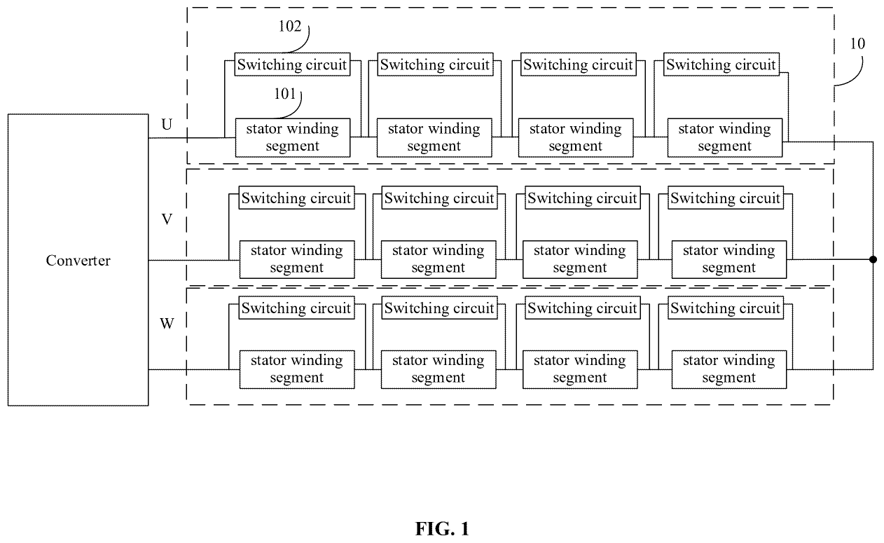

Reference is made to FIG. 1, which is a schematic diagram of a rolling power supply circuit for a long stator linear motor according to an embodiment of the present disclosure. As shown in FIG. 1, the rolling power supply circuit includes three-phase stator winding branches 10 configured to connect to a converter.

Each of the three-phase stator winding branches 10 includes N stator winding segments 101 connected in series, and the N stator winding segments 101 are connected in parallel to respective switching circuits 102. In response to a switching circuit 102 being closed, the stator winding segment 101 connected in parallel to the switching circuit 102 is short-circuited.

In the embodiment, the rolling power supply circuit includes three-phase stator winding branches 10, which are a U-phase stator winding branch 10, a V-phase stator winding branch 10, and a W-phase stator winding branch 10. The three-phase stator winding branches 10 are configured to connect to a converter. The U-phase stator winding branch 10 is supplied with U-phase power, the V-phase stator winding branch 10 is supplied with V-phase power, and the W-phase stator winding branch 10 is supplied with W-phase power. Each of the three-phase stator winding branches 10 includes N stator winding segments 101 connected in series, and the N stator winding segments 101 are connected in parallel to respective switching circuits 102. When one of the switching circuits 102 is closed, the stator winding segment 101 connected in parallel to the switching circuit 102 is short-circuited and therefore is not powered. When the switching circuit 102 is opened, the stator winding segment 101 connected in parallel to the switching circuit 102 is powered. A quantity of the stator winding segments 101 connected in series in each of the three-phase stator winding branches 10 may be determined based on the actual situation. A space interval between every two of the N stator winding segments 101 connected in series in each of the three-phase stator winding branches 10 is particularly small, approximately being zero.

In some embodiments, the respective stator winding segments 101 in the three-phase stator winding branches 10 are equal to each other in length.

In the embodiment, stator winding segments 101 in a same stator winding branch 10 are equal to each other in length, and stator winding segments 101 across different stator winding branches 10 are also equal to each other in length.

It can be understood that not all of the respective stator winding segments 101 in the three-phase stator winding branches 10 may be equal to each other in length. A length of each stator winding segment 101 may be determined based on the actual situation.

In some embodiments, head ends of the three-phase stator winding branches 10 are connected to the converter, and tail ends of the three-phase stator winding branches 10 are connected in a star connection manner.

In the embodiment, the head ends of the three-phase stator winding branches 10 are connected to the converter, and the tail ends of the three-phase stator winding branches 10 are connected in the star connection manner.

By closing or opening switching circuits 102, stator winding segments 101 connected in parallel to the switching circuits 102 may be powered or not powered. In some embodiments, the switching circuits 102 connected in parallel to the stator winding segments 101 with a same segment number in the three-phase stator winding branches 10 are controlled by a same control signal, in order to implement simultaneous switching for the U, V and W phases to ensure precise and synchronous control over the three phases.

In the embodiment, the respective stator winding segments 101 are connected in parallel to different switching circuits 102, and the switching circuits 102 connected in parallel to the stator winding segments 101 with a same segment number in the three-phase stator winding branches 10 are controlled by a same control signal.

For example, as shown in FIG. 1, each of the U-phase stator winding branch 10, the V-phase stator winding branch 10, and the W-phase stator winding branch 10 includes four stator winding segments 101. A switching circuit 102 connected in parallel to a first stator winding segment 101 in the U-phase stator winding branch 10, a switching circuit 102 connected in parallel to a first stator winding segment 101 in the V-phase stator winding branch 10, and a switching circuit 102 connected in parallel to a first stator winding segment 101 in the W-phase stator winding branch 10 are controlled by a same control signal, which is denoted as a control signal 1. A switching circuit 102 connected in parallel to a second stator winding segment 101 in the U-phase stator winding branch 10, a switching circuit 102 connected in parallel to a second stator winding segment 101 in the V-phase stator winding branch 10, and a switching circuit 102 connected in parallel to a second stator winding segment 101 in the W-phase stator winding branch 10 are controlled by a same control signal, which is denoted as a control signal 2. A switching circuit 102 connected in parallel to a third stator winding segment 101 in the U-phase stator winding branch 10, a switching circuit 102 connected in parallel to a third stator winding segment 101 in the V-phase stator winding branch 10, and a switching circuit 102 connected in parallel to a third stator winding segment 101 in the W-phase stator winding branch 10 are controlled by a same control signal, which is denoted as a control signal 3. A switching circuit 102 connected in parallel to a fourth stator winding segment 101 in the U-phase stator winding branch 10, a switching circuit 102 connected in parallel to a fourth stator winding segment 101 in the V-phase stator winding branch 10, and a switching circuit 102 connected in parallel to a fourth stator winding segment 101 in the W-phase stator winding branch 10 are controlled by a same control signal, which is denoted as a control signal 4.

As described above, the switching circuit 102 connected in parallel to the first stator winding segment 101 in the U-phase stator winding branch 10, the switching circuit 102 connected in parallel to the first stator winding segment 101 in the V-phase stator winding branch 10, and the switching circuit 102 connected in parallel to the first stator winding segment 101 in the W-phase stator winding branch 10 may be simultaneously closed by the control signal 1, thus simultaneously short-circuiting the first stator winding segment 101 in the U-phase stator winding branch 10, the first stator winding segment 101 in the V-phase stator winding branch 10 and the first stator winding segment 101 in the W-phase stator winding branch 10. The switching circuit 102 connected in parallel to the second stator winding segment 101 in the U-phase stator winding branch 10, the switching circuit 102 connected in parallel to the second stator winding segment 101 in the V-phase stator winding branch 10, and the switching circuit 102 connected in parallel to the second stator winding segment 101 in the W-phase stator winding branch 10 may be simultaneously closed by the control signal 2, thus simultaneously short-circuiting the second stator winding segment 101 in the U-phase stator winding branch 10, the second stator winding segment 101 in the V-phase stator winding branch 10 and the second stator winding segment 101 in the W-phase stator winding branch 10. Similarly, the switching circuit 102 connected in parallel to the fourth stator winding segment 101 in the U-phase stator winding branch 10, the switching circuit 102 connected in parallel to the fourth stator winding segment 101 in the V-phase stator winding branch 10, and the switching circuit 102 connected in parallel to the fourth stator winding segment 101 in the W-phase stator winding branch 10 may be simultaneously closed by the control signal 4, thus simultaneously short-circuiting the fourth stator winding segment 101 in the U-phase stator winding branch 10, the fourth stator winding segment 101 in the V-phase stator winding branch 10 and the fourth stator winding segment 101 in the W-phase stator winding branch 10.

In addition to the above embodiments, the switching circuits 102 connected in parallel to the stator winding segments 101 with the same segment number in the three-phase stator winding branches 10 may be controlled by different control signals.

The switching circuits 102, upon being closed, function to short-circuit stator winding segments 101 connected in parallel to the switching circuits 102, respectively. The switching circuits 102 may be configured in different structures under a condition that the above function is implemented.

In some embodiments, each of the switching circuits 102 includes an electronic switch, in order to simplify the circuit structure and reduce cost. The stator winding segments 101 are powered or not powered by turning on or off the electronic switch.

A stator winding segment 101 is an energy storage element. Therefore, when the switching circuit 102 connected in parallel to the stator winding segment 101 is closed, the stator winding segment 101 and the switching circuit 102 form a transient closed loop, causing a discharging process. As a result, a fluctuation occurs in a circuit of the stator winding segment 101, causing a fluctuation in the traction force of a motor. In addition, during power supply switching for a stator winding segment 101, a currently closed switching circuit 102 is opened, and a motor impedance is changed from zero impedance (or low impedance) of the switching circuit 102 to a high impedance of the stator winding segment 101. In the process, a current is established for a long time period, generating a current fluctuate. To reduce the fluctuation of a current flowing through the stator winding segment 101, a length of the stator winding segment 101 may be reduced as much as possible to reduce an impedance of the stator winding segment 101. A length of a stator winding segment 101 may be determined in conjunction with a moving speed of a rotor and a switching delay of the electronic switch, so as to ensure that a stator winding segment 101 has been powered when the rotor moves into the stator winding segment 101.

To sum up, in the rolling power supply circuit for a long stator linear motor in the present disclosure, stator winding segments are powered or not powered by closing or opening switching circuits, thereby improving the speed of power supply switching for the stator winding segments. In addition, live switching is implemented, which effectively reduces the usage amount of the converter and system complexity and thereby reducing the line cost. Moreover, the control on the rolling power supply circuit is highly flexible, and multiple adjacent stator winding segments are powered simultaneously by opening the switching circuits connected in parallel to the multiple adjacent stator winding segments. Furthermore, by reducing lengths of stator winding segments, increasing a total quantity of the stator winding segments, and adopting switching between multiple series-connected stator winding segments, fluctuations in motor traction force during power supply switching can be reduced.

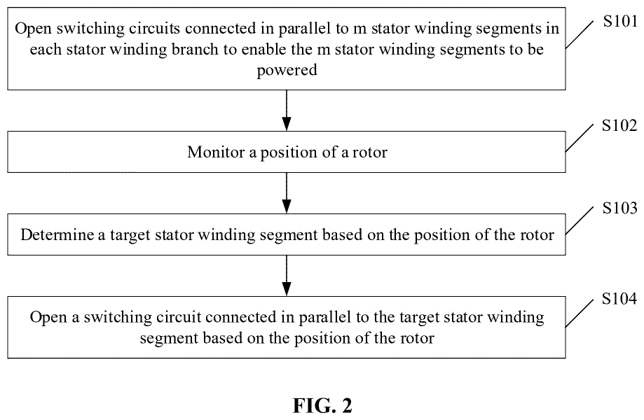

A rolling power supply method for a long stator linear motor is further provided in the present disclosure. Reference is made to FIG. 2, which is a flowchart of a rolling power supply method for a long stator linear motor according to an embodiment of the present disclosure. The rolling power supply method is applied to the rolling power supply circuit for a long stator linear motor described in the above embodiments and includes the following steps S101, S102, S103 and S104.

In step S101, switching circuits connected in parallel to m stator winding segments in each of the three-phase stator winding branches are opened to enable the m stator winding segments to be powered.

In step S102, a position of a rotor is monitored.

In step S103, a target stator winding segment is determined based on the position of the rotor.

In step S104, the switching circuit connected in parallel to the target stator winding segment is opened based on the position of the rotor.

In an initial state, switching circuits connected in parallel to all stator winding segments are closed. To supply power, switching circuits connected in parallel to m adjacent stator winding segments in each of the three-phase stator winding branches are opened. m is a positive integer. In this case, the m stator winding segments are powered. During the movement of the rotor, the position of the rotor is monitored. Based on the position, the target stator winding segment is determined and a switching circuit connected in parallel to the target stator winding segment is opened. The target stator winding segment refers to a stator winding segment to be powered.

In some embodiments, opening the switching circuits connected in parallel to m stator winding segments in each of the three-phase stator winding branches includes:

opening the switching circuits connected in parallel to m adjacent stator winding segments in each of the three-phase stator winding branches, where m is greater than or equal to 2.

The determining the target stator winding segment based on the position of the rotor includes:
determining, in response to the rotor being currently located at an n-th stator winding segment, an (n+m)-th stator winding segment in a movement direction of the rotor as the target stator winding segment.

The opening the switching circuit connected in parallel to the target stator winding segment includes:
in response to a tail end of the rotor leaving the n-th stator winding segment, opening a switching circuit connected in parallel to the (n+m)-th stator winding segment and closing a switching circuit connected in parallel to the n-th stator winding segment.

In the embodiment, at least two stator winding segments are powered simultaneously, and switching between m series-connected segments is adopted. In a normal operating state, m adjacent stator winding segments in a stator winding branch are powered simultaneously. During power supply switching between stator winding segments, in response to a tail end of the rotor leaving the n-th stator winding segment, the switching circuit connected in parallel to the (n+m)-th stator winding segment is opened, the switching circuit connected in parallel to an n-th stator winding segment is closed, and switching circuits connected in parallel to an (n+1)-th stator winding segment to an (n+m-1)-th stator winding segment remain to be opened.

For example, m is 2, that is, switching of two series-connected segments is adopted. In a normal operating state, two adjacent stator winding segments in each stator winding branch are powered simultaneously. That is, in the normal operating state, when a rotor is located at an n-th stator winding segment, switching circuits connected in parallel to the n-th stator winding segment and the (n+1)-th stator winding segment are opened. As a result, the n-th stator winding segment and the (n+1)-th stator winding segment are powered simultaneously, and stator winding segments other than the n-th stator winding segment and the (n+1)-th stator winding segment are short-circuited. During power supply switching for stator winding segments, in response to a tail end of the rotor leaving the n-th stator winding segment, a switching circuit connected in parallel to an (n+2)-th stator winding segment is opened, the switching circuit connected in parallel to the n-th stator winding segment is closed, and the switching circuit connected in parallel to the (n+1)-th stator winding segment remains to be opened.

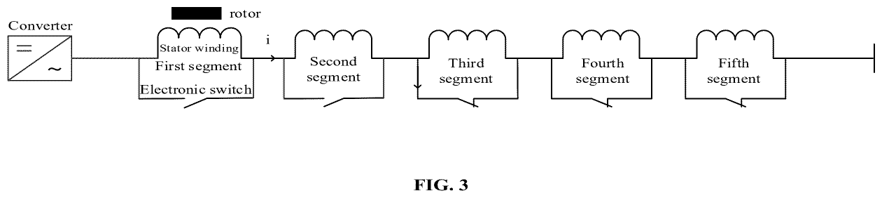

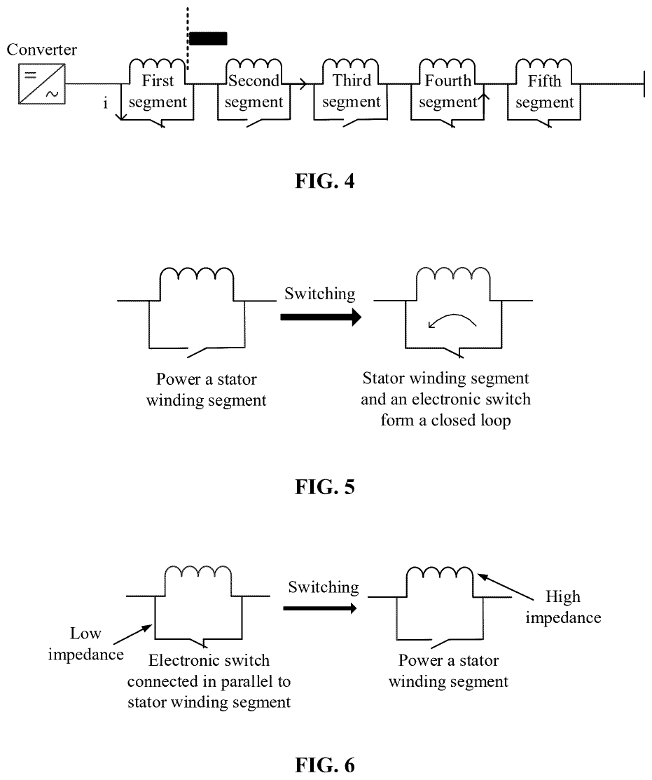

One of the three-phase stator winding branches is taken as an example. As shown in FIG. 3 and FIG. 4, when a rotor is located at a first stator winding segment, switching circuits connected in parallel to the first stator winding segment and a second stator winding segment are opened. As a result, the first stator winding segment and the second stator winding segment are powered simultaneously, and stator winding segments other than the first stator winding segment and the second stator winding segment are short-circuited. In response to a tail end of the rotor leaving the first stator winding segment, a switching circuit connected in parallel to a third stator winding segment is opened, the switching circuit connected in parallel to the first stator winding segment is closed, and the switching circuit connected in parallel to the second stator winding segment remains to be opened. As a result, the second stator winding segment and the third stator winding segment are powered simultaneously. In response to the tail end of the rotor leaving the second stator winding segment, a switching circuit connected in parallel to a fourth stator winding segment is opened, the switching circuit connected in parallel to the second stator winding segment is closed, and the switching circuit connected in parallel to the third stator winding segment remains to be opened. As a result, the third stator winding segment and the fourth stator winding segment are powered simultaneously. In response to a tail end of the rotor leaving the third stator winding segment, a switching circuit connected in parallel to a fifth stator winding segment is opened, the switching circuit connected in parallel to the third stator winding segment is closed, and the switching circuit connected in parallel to the fourth stator winding segment remains to be opened. As a result, the fourth stator winding segment and the fifth stator winding segment are powered simultaneously.

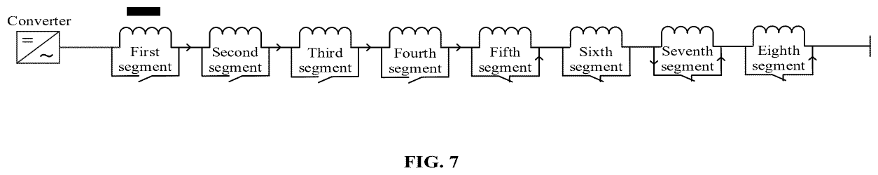

Referring to FIG. 5, a stator winding is an energy storage element. Therefore, when a switching circuit connected in parallel to the stator winding is closed, the stator winding and the switching circuit form a transient closed loop, causing a discharging process. As a result, a fluctuation occurs in a circuit of the stator winding, causing a fluctuation in the traction force of a motor. In addition, referring to FIG. 6, during power supply switching for a stator winding, a currently closed switching circuit is opened, and a motor impedance is changed from zero impedance (or low impedance) of the switching circuit to a high impedance of the stator winding. In the process, a current is established for a long time period, generating a current fluctuate. To reduce the fluctuation of a current flowing through the stator winding, a length of the stator winding may be reduced as much as possible, and switching between multiple series-connected segments may be adopted.

In an example, a length of a stator winding is reduced and switching between four series-connected segments is adopted. In a normal operating state, four adjacent stator winding segments in a stator winding branch are powered simultaneously. That is, in the normal operating state, when a rotor is located at an n-th stator winding segment, switching circuits connected in parallel to the n-th stator winding segment, an (n+1)-th stator winding segment, an (n+2)-th stator winding segment, and an (n+3)-th stator winding segment are opened. As a result, the n-th stator winding segment, the (n+1)-th stator winding segment, the (n+2)-th stator winding segment, and the (n+3)-th stator winding segment are powered simultaneously, and stator winding segments other than the n-th stator winding segment, the (n+1)-th stator winding segment, the (n+2)-th stator winding segment, and the (n+3)-th stator winding segment are short-circuited. During power supply switching for stator winding segments, in response to a tail end of the rotor leaving the n-th stator winding segment, a switching circuit connected in parallel to an (n+4)-th stator winding segment is opened and a switching circuit connected in parallel to the n-th stator winding segment is closed. Switching circuits connected in parallel to the (n+1)-th stator winding segment, the (n+2)-th stator winding segment and the (n+3)-th stator winding segment remain to be opened.

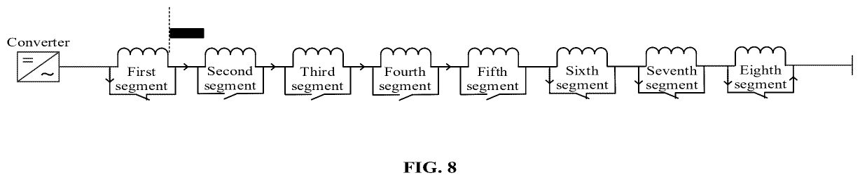

One of the three-phase stator winding branch is taken as an example. As shown in FIG. 7 and FIG. 8, when a rotor is located at a first stator winding segment, switching circuits connected in parallel to the first stator winding segment to a fourth stator winding segment are opened. As a result, the first stator winding segment to the fourth stator winding segment are powered simultaneously, and stator winding segments other than the first stator winding segment to the fourth stator winding segment are short-circuited. In response to a tail end of the rotor leaving the first stator winding segment, a switching circuit connected in parallel to a fifth stator winding segment is opened, the switching circuit connected in parallel to the first stator winding segment is closed, and the switching circuits connected in parallel to the second stator winding segment to the fourth stator winding segment remain to be opened. As a result, the second stator winding segment to the fifth stator winding segment are powered simultaneously. In response to the tail end of the rotor leaving the second stator winding segment, a switching circuit connected in parallel to a sixth stator winding segment is opened, the switching circuit connected in parallel to the second stator winding segment is closed, and the switching circuits connected in parallel to the third stator winding segment to the fifth stator winding segment remain to be opened. As a result, the third stator winding segment to the sixth stator winding segment are powered simultaneously. In response to a tail end of the rotor leaving the third stator winding segment, a switching circuit connected in parallel to a seventh stator winding segment is opened, the switching circuit connected in parallel to the third stator winding segment is closed, and the switching circuits connected in parallel to the fourth stator winding segment to the seventh stator winding segment remain to be opened. As a result, the fourth stator winding segment to the seventh stator winding segment are powered simultaneously. In response to a tail end of the rotor leaving the fourth stator winding segment, a switching circuit connected in parallel to an eighth stator winding segment is opened, the switching circuit connected in parallel to the fourth stator winding segment is closed, and the switching circuits connected in parallel to the fifth stator winding segment to the eighth stator winding segment remain to be opened. As a result, the fifth stator winding segment to the eighth stator winding segment are powered simultaneously.

With the rolling power supply method for a long stator linear motor in the present disclosure, stator winding segments are powered or not powered by closing and opening switching circuits, thereby improving the speed of power supply switching for the stator winding segments. In addition, live switching is implemented, which effectively reduces the usage amount of the converter and system complexity and thereby reducing the line cost. Moreover, the control on the rolling power supply circuit is highly flexible, and multiple adjacent stator winding segments are powered simultaneously by opening the switching circuits connected in parallel to the multiple adjacent stator winding segments. Furthermore, by reducing lengths of stator winding segments, increasing a total quantity of the stator winding segments, and adopting switching between multiple series-connected stator winding segments, fluctuations in motor traction force during power supply switching can be reduced.

A long stator linear motor is further provided in the present disclosure. The long stator linear motor includes the above-described rolling power supply circuit for a long stator linear motor. The long stator linear motor is not repeatedly described herein and may be referred to the above-described embodiments of the rolling power supply circuit.

The above embodiments in the specification are described in a progressive manner. Each of the embodiments mainly focuses on its differences from other embodiments. The same and similar parts between the various embodiments can be referred to each other.

Those skilled in the art may further realize that the units and algorithm steps of each example described in conjunction with the embodiments disclosed herein can be implemented by electronic hardware, computer software, or a combination of both. In order to clearly illustrate the interchangeability of hardware and software, the compositions and steps of each example have been described in general terms of functionality in the above description. Whether these functions are performed in hardware or software depends on the specific application and design constraints for the technical solution. Those skilled in the art may use different methods to implement the described functions for each specific application, and such implementation should not be regarded as going beyond the scope of the present disclosure.

The steps of the method or algorithm described in conjunction with the embodiments disclosed herein may be directly implemented by hardware, a software module executed by a processor, or a combination thereof. The software module may be embedded in a random access memory (RAM), a memory, a read-only memory (ROM), an electrical programmable ROM, an electrically erasable programmable ROM, a register, a hardware disk, a removable magnetic disk, a CD-ROM, or any other forms of storage medium well known in the art.

The rolling power supply circuit for a long stator linear motor, the rolling power supply method and the long stator linear motor in the present disclosure are described in detail above. The principle and the embodiments of the present disclosure are illustrated herein by specific examples. The above description of examples is only intended to facilitate understanding of the method and the idea of the present disclosure. It should be noted that, those skilled in the art may make several improvements and modifications to the present disclosure without departing from the principles of the present disclosure. These improvements and modifications shall fall within the protection scope of the claims of the present disclosure.

1. A rolling power supply circuit for a long stator linear motor, comprising three-phase stator winding branches, wherein the three-phase stator winding branches are configured to connect to a converter; and
each of the three-phase stator winding branches comprises N stator winding segments connected in series, and the N stator winding segments are connected in parallel to respective switching circuits, wherein
in response to a switching circuit among the respective switching circuits being closed, the stator winding segment connected in parallel to the switching circuit is short-circuited.

2. The rolling power supply circuit for a long stator linear motor according to claim 1, wherein the switching circuits connected in parallel to the stator winding segments with a same segment number in the three-phase stator winding branches are controlled by a same control signal.

3. The rolling power supply circuit for a long stator linear motor according to claim 1, wherein head ends of the three-phase stator winding branches are connected to the converter, and tail ends of the three-phase stator winding branches are connected in a star connection manner.

4. The rolling power supply circuit for a long stator linear motor according to claim 1, wherein the respective stator winding segments in the three-phase stator winding branches are equal to each other in length.

5. The rolling power supply circuit for a long stator linear motor according to claim 1, wherein the respective switching circuits each comprise an electronic switch.

6. A rolling power supply method for a long stator linear motor, applied to the rolling power supply circuit for a long stator linear motor according to claim 1, wherein the rolling power supply method comprises:
opening switching circuits connected in parallel to m stator winding segments among the N stator winding segments in each of the three-phase stator winding branches to enable the m stator winding segments to be powered;
monitoring a position of a rotor;
determining a target stator winding segment from the N stator winding segments based on the position of the rotor; and
opening, based on the position of the rotor, a switching circuit connected in parallel to the target stator winding segment.

7. The rolling power supply method for a long stator linear motor according to claim 6, wherein the opening switching circuits connected in parallel to m stator winding segments comprises:
opening the switching circuits connected in parallel to the m adjacent stator winding segments among the N stator winding segments in each of the three-phase stator winding branches, wherein m is greater than or equal to 2.

8. The rolling power supply method for a long stator linear motor according to claim 7, wherein the determining the target stator winding segment based on the position of the rotor comprises:
determining, in response to the rotor being currently located at an n-th stator winding segment, an (n+m)-th stator winding segment in a movement direction of the rotor as the target stator winding segment.

9. The rolling power supply method for a long stator linear motor according to claim 8, wherein the opening, based on the position of the rotor, the switching circuit connected in parallel to the target stator winding segment comprises:
in response to a tail end of the rotor leaving the n-th stator winding segment, opening a switching circuit connected in parallel to the (n+m)-th stator winding segment and closing a switching circuit connected in parallel to the n-th stator winding segment.

10. A long stator linear motor, comprising the rolling power supply circuit for a long stator linear motor according to claim 1.

11. The rolling power supply circuit for a long stator linear motor according to claim 1, wherein the switching circuits connected in parallel to the stator winding segments with a same segment number in the three-phase stator winding branches are controlled by different control signals.

12. The rolling power supply circuit for a long stator linear motor according to claim 1, wherein not all of the respective stator winding segments in the three-phase stator winding branches are equal to each other in length.

13. The rolling power supply method for a long stator linear motor according to claim 6, wherein before the opening switching circuits connected in parallel to m stator winding segments, the rolling power supply method further comprises:
closing the switching circuits connected in parallel to all the stator winding segments in the three-phase stator winding branches.
